(19) United States
(12) Patent Application Publication
(10) Pub. No.: US 2003/0191804 A1
(43) Pub. Date: Oct. 9, 2003

(54) Virtual storage system and virtual storage service providing method

(75) Inventors: Hideto Yasuda, Shinagawa (JP); Satoshi Takahashi, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: FUJITSU LIMITED, Kawasaki (JP)

(21) Appl. No.: 10/436,103

(22) Filed: May 13, 2003

Related U.S. Application Data
(63) Continuation of application No. PCT/JP00/08406, filed on Nov. 29, 2000.

(51) Int. Cl. G06F 15/16; G06F 17/00

(52) U.S. Cl. 709/203; 707/104.1; 709/218

(57) ABSTRACT

A virtual storage system which stores data generated by a search engine on the Internet according to a request from an information terminal is constructed to include a storage server which stores the data generated by the search engine, by receiving the data without passing the data through the information terminal.

### TECHNICAL FIELD

The present invention generally relates to virtual storage systems and virtual storage service providing methods, and more particularly to a virtual storage system which stores data generated by a search engine on the Internet in response to an access from an information terminal, and to a virtual storage service providing method which provides a service for storing the data generated by the search engine.

In this specification, an information terminal includes various kinds of apparatuses which have an Internet function capable of connecting to the Internet, such as a browser. Accordingly, the information terminal includes desk-top and portable personal computers, and telephone sets, intelligent television apparatuses, portable telephone sets, game apparatuses, mobile terminals and the like respectively having the Internet function.

### BACKGROUND ART

Access to information of various sites on the Internet are frequently made using the browser of the information terminal such as the personal computer. The data generated by the search engine on the Internet, based on the accessed information, may not be generatable again in most cases, because the information provided at the sites on the Internet changes with lapse of time. Hence, there are demands to store the data generated by the search engine in a retrievable manner.

Examples of cases where it is desirable to store the data generated by the search engine include, a case where it is desirable to temporarily store a list of information obtained by carrying out complicated processes by the search engine together with contents which are directly linked to the contents of the list, a case where it is desirable to temporarily store tabulated results obtained by a standardized business application on the Internet using a database for business use together with contents supplementing the tabulated results, a case where it is desirable to temporarily store an original page of a homepage on the Internet together with a translation of the page, a case where it is desirable to temporarily store intermediate results and the like of a game which is downloaded by the search engine, and a case where it is desirable to temporarily store an attached file of a browser mail.

In the case of the personal computer or the like, a storage capacity of a storage apparatus used is relatively large, and the data generated by the search engine can be stored in the storage apparatus. However, in the case of a portable information terminal such as the portable telephone set, the storage capacity of the storage apparatus used is relatively small, and the data generated by the search engine cannot be stored in the storage apparatus due to the limited storage capacity. In addition, even in the case of the personal computer or the like, if the amount of data generated by the search engine is extremely large, the storage apparatus may not have enough storage capacity to spare, and in such a case, it is desirable to store the extremely large amount of data somewhere else.

Accordingly, at portal sites of an application service provider (ASP) and Internet service provide (ISP) on the Internet, a so-called disk rental service is provided with respect to the users for the purpose of storing the data. When using this disk rental service, the user sends the data which is generated by the search engine and stored in the storage apparatus of the personal computer or the like to a server that is providing the disk rental service, so that the data is stored in a disk which is rented to the user.

However, the following problems 1 through 5 are encountered in the disk rental service.

Problem 1: The data that can be stored in the disk rented to the user is limited to the data which is once stored in the storage apparatus of the personal computer or the like. For this reason, the disk rental service cannot be used from the information terminal, such as the portable information terminal, which does not have a storage apparatus with a sufficient storage capacity to store the data. Accordingly, the information terminal from which the disk rental service can be used is limited, and the kind of access using the search engine on the Internet is determined by the storage capacity of the information terminal.

Problem 2: When using the disk rental service, the user must send the data to the server that is providing the disk rental service by accessing the server from the personal computer or the like, and as a result, at least telephone charges related to the connection to the server and connection charges related to the connection to the provider are generated. For this reason, in addition to the charges for using the disk rental service itself, the charges related to the communication are also generated, thereby increasing the cost of using the disk rental service the more the disk rental service is used.

Problem 3: The data that is stored by use of the disk rental service remains stored until the user deletes the data. For this reason, unnecessary data remain stored in most cases, and from the point of view of the provider of the disk rental service, it is necessary to provide the disk rental service by preparing a storage capacity which is more than necessary, thereby increasing the maintenance cost for the provider of the disk rental service.

Problem 4: The user who wishes to use the disk rental service must use a personal computer or the like, and cannot use a portable telephone set or the like which is simple to operate. For this reason, the user must be skilled at least on the operation of the personal computer or the like, and from the point of view of the provider of the disk rental service, it is difficult to greatly increase the number of such skilled users who wish to use the disk rental service.

Problem 5: The user of the disk rental service has a usable upper limit storage capacity which is determined at the time of contract, and cannot freely change the storage capacity to be used. If the usable upper limit storage capacity of the user were frequently increased, the provider of the disk rental service would have to prepare an extremely large storage capacity in order to be able to cope with a situation where all of the users increase the usable upper limit storage capacity. But if such an extremely large storage capacity were prepared, the utilization efficiency of the storage capacity would become poor, and the maintenance cost for the disk rental service will become high for the provider.

### DISCLOSURE OF THE INVENTION

Accordingly, it is a general object of the present invention to provide a novel and useful virtual storage system and virtual storage service providing method, in which the problems described above are eliminated.

Another and more specific object of the present invention is to provide a virtual storage system and a virtual storage service providing system, which do not limit the information terminal which can receive a service, do not limit a usable storage capacity and minimize costs for using the service for the user, and improve the utilization efficiency of the storage capacity which is provided, make it unnecessary to prepare an unnecessarily large storage capacity and realize low maintenance costs for the provider of the service.

Still another object of the present invention is to provide a virtual storage system which stores data generated by a search engine on the Internet according to a request from an information terminal, comprising a storage server which stores the data generated by the search engine, by receiving the data without passing the data through the information terminal. According to the virtual storage system of the present invention, the information terminal which can receive the service is not limited, a usable storage capacity is not limited, and costs for using the service is minimized at the user end, and at the service provider end, the utilization efficiency of the storage capacity which is provided is improved, thereby making it unnecessary to prepare an unnecessarily large storage capacity, and low maintenance costs can be realized.

A further object of the present invention is to provide a virtual storage service providing method which provides a service for storing data generated by a search engine on the Internet according to a request from the information terminal, comprising a step of storing the data generated by the search engine without passing the data through the information terminal. According to the virtual storage service providing method of the present invention, the information terminal which can receive the service is not limited, a usable storage capacity is not limited, and costs for using the service is minimized at the user end, and at the service provider end, the utilization efficiency of the storage capacity which is provided is improved, thereby making it unnecessary to prepare an unnecessarily large storage capacity, and low maintenance costs can be realized.

Other objects and further features of the present invention will be apparent from the following detailed description when read in conjunction with the accompanying drawings.

### BRIEF DESCRIPTION OF THE DRAWING

FIG. 1 is a diagram showing a communication system to which an embodiment of a virtual storage system according to the present invention may be applied;

FIG. 2 is a diagram for explaining a module structure of the embodiment of the virtual storage system;

FIG. 3 is a flow chart for explaining a storage process;

FIG. 4 is a flow chart for explaining a user registration process and an accounting method setting process;

FIG. 5 is a flow chart for explaining a user authentication process;

FIG. 6 is a flow chart for explaining an inquiry process to a content public server;

FIG. 7 is a flow chart for explaining a content catalog creating process for an inquiry result list;

FIG. 8 is a flow chart for explaining a content collecting and storage process of a storage server;

FIG. 9 is a flow chart for explaining a notification process for storage information, accounting information and log information;

FIG. 10 is a flow chart for explaining a referring process;

FIG. 11 is a flow chart for explaining an inquiry process to a storage server;

FIG. 12 is a flow chart for explaining an accounting process; and

FIG. 13 is a diagram for explaining a display screen which is displayed on a display part of the information terminal in the embodiment.

### BEST MODE OF CARRYING OUT THE INVENTION

A description will be given of various embodiments of a virtual storage system and a virtual storage service providing method according to the present invention, by referring to the drawings.

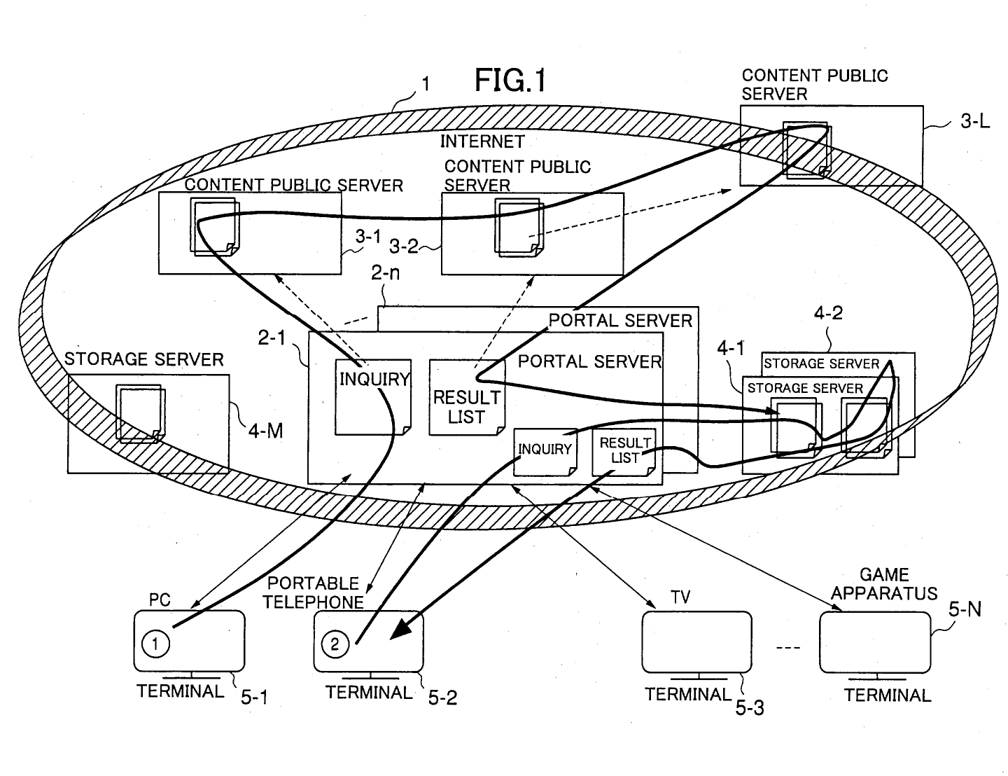

FIG. 1 is a diagram showing a communication system to which an embodiment of the virtual storage system according to the present invention may be applied. This embodiment of the virtual managing system employs an embodiment of the virtual storage service providing method according to the present invention.

The communication system shown in FIG. 1 generally includes a network comprising the Internet 1, portal servers 2-1 through 2-n, content public servers 3-1 through 3-L and storage servers 4-1 through 4-M respectively provided on the Internet 1, and information terminals 5-1 through 5-N having an Internet function capable of connecting to the Internet 1. Each of the portal servers 2-1 through 2-n, the content public servers 3-1 through 3-L and storage servers 4-1 through 4-M has a known server hardware structure including a CPU, a storage section and the like. In addition, each of the information terminals 5-1 through 5-N has a known information terminal hardware structure including a CPU, a storage section and the like. For example, the information terminal 5-1 is formed by a personal computer (PC), the information terminal 5-2 is formed by a portable telephone set, the information terminal 5-3 is formed by an intelligent television apparatus, and the information terminal 5-N is formed by a game apparatus.

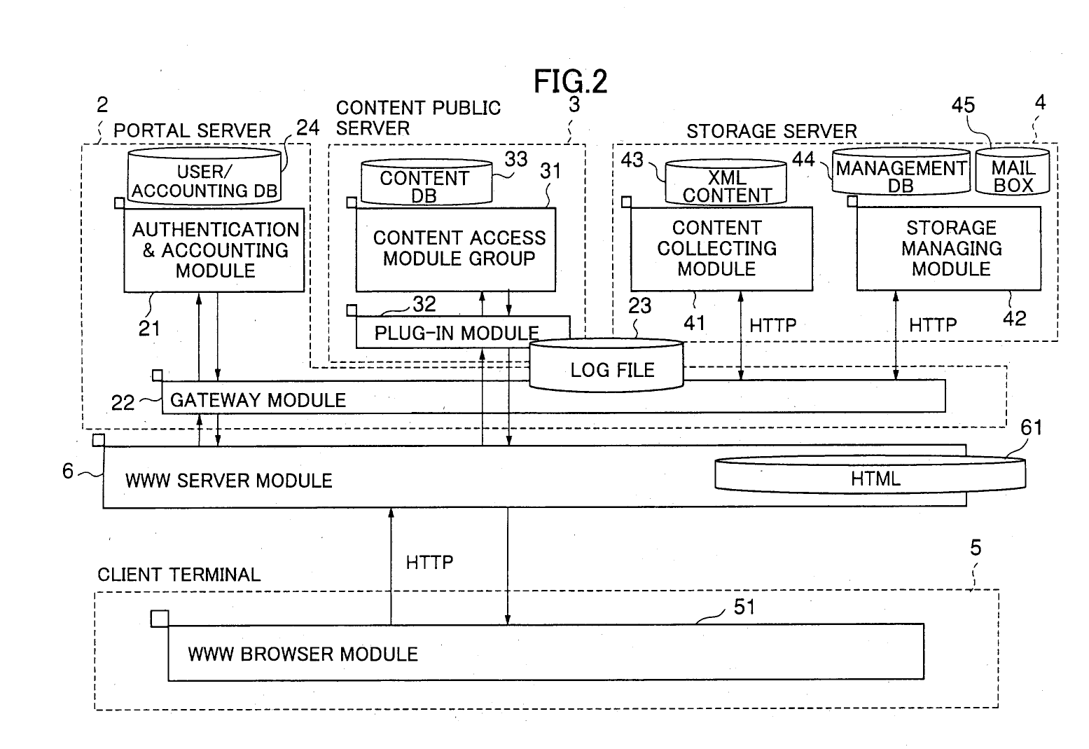

FIG. 2 is a diagram for explaining a module structure of this embodiment of the virtual storage system. For the sake of convenience, only one each of the portal server, the content public server, the storage server and the information terminal are shown in FIG. 2, and the illustration of the Internet is omitted.

In FIG. 2, the portal server 2 includes an authentication and accounting module 21, a gateway module 22, a log file 23, and a user and accounting database (DB) 24. The content public server 3 includes a content access module group 31, a plug-in module 32, and a content database (DB) 33. The storage server 4 includes a content collecting module 41, a storage managing module 42, an XML content file 43, a management database (DB) 44, and a mailbox 45. The information terminal (client terminal) 5 includes a www browser module 51.

A www server module 6 of a www server has a known structure provided with an HTML file 61, and enables connection of the information terminal 5, the portal server 2, the content public server 3 and the storage server 4 via the Internet 1. In other words, the www server module 6 is provided in each of the portal server 2, the content public server 3 and the storage server 4, but is illustrated for the sake of convenience in FIG. 2 as a module within a single www server. In addition, the illustration of the www server is omitted in FIG. 1.

A communication between the www browser 51 of the information terminal 5 and the www server module 6 is carried out by HTTP. Further, communications between the gateway module 22 of the portal server 2 and the content collecting module 41 and the storage managing module 42 of the storage server 4 are also carried out by HTTP.

In this embodiment, it is assumed for the sake of convenience that known module structures are used for the authentication and accounting module 21 and the gateway module 22 of the portal server 2, the content access module group 31 of the content public server 3, the www browser module 51 of the information terminal 5, and the www server module 6 of the www server. In addition, it is assumed for the sake of convenience that a known search engine is included in the content access module group 31 of the content public server 3.

When an information search and store request is generated with respect to the content public server 3 from the www browser module 51 of the information terminal 5, this request is sent to the www server. The www server module 6 of the www server carries out an HTML editing based on the HTML file 61 depending on the request, and carries out a CGI software communication to start the search engine within the content module group 31 of the content public server 3 via the gateway module 22 of the portal server 2. The search engine searches the content database 33, creates a search result, and sends the search result to the www browser module 51 of the information terminal 5 via the www server module 6.

The plug-in module 32 of the content public server 3 monitors the start of the search engine. In addition, if a store request is included in the request from the www browser module 51 of the information terminal 5, an interrupt is generated with respect to the sending of the search result, the HTML of the search result is analyzed, related URLs are collected, and the content (content catalog) to be stored is created. In addition, the plug-in module 32 sends the content to be stored, via the gateway module 22 of the portal server 2, to the storage server 4 directly, without passing through the information terminal 5. The plug-in module 32 may be provided within the portal server 2 or, provided within both the portal server 2 and the content public server 3.

When the storage server 4 receives the content (content catalog) to be stored in the content collecting module 41, the storage server 4 repeats the access to the related URL site and the storage of the HTML file a number of times corresponding to the number of related URLs, and creates an XML storage content. The XML storage content is stored in the XML content file 43. The XML storage content may be subjected to a known enciphering process before being stored in the XML content file 43. The storage managing module 42 stores and manages the XML storage content, information related to the corresponding user, and the like, using the management database 44 and the mailbox 45.

When referring to the XML storage content from the information terminal 5, the www browser 51 generates a stored information referring request, and the storage server 4 is accessed via the www server and the portal server 2. At the storage server 4, the XML storage content read from the XML content file 43 is converted into an HTML content by the content collecting module 41, and is sent by the storage managing module 42 to the information terminal 5 via the portal server 2 and the www server.

The authentication and accounting module 21 of the portal server 2 carries out an accounting process at the time of the information search and an accounting process at the time of the referring to the stored information, using similar techniques.

Accordingly, when storing the data (content) generated by the search engine in the storage server 4, the data is not temporarily stored within the information terminal 5, but is sent directly to the storage server 4 from the portal server 2 and stored in the storage server 4. Hence, it is possible to store the data in the storage server 4, regardless of the storage capacity of the information terminal 5. In other words, the information terminal of the user to receive the virtual storage service is not limited as in the case of the conventional disk rental service, and it is sufficient for the information terminal to simply have the Internet function capable of connecting to the Internet 1. In addition, since the data to be stored is sent directly to the storage server 4 from the portal server 2 and stored in the storage server 4, without temporarily storing the data within the information terminal 5, the user of the virtual storage service does not need to be skilled in the operation of the personal computer or the like, and only needs to understand simple Internet functions. Accordingly, the storage server 4 can provide a virtual storage service, as if providing rental virtual electronic lockers on the Internet 1, with respect to a large number of users including the users who are not skilled in the operation of the personal computer or the like.

Moreover, when viewed from the provider of the virtual storage service (virtual storage service provider), the storage section (XML file 43) for storing the data is not limited to one location, and the storage sections of the plurality of storage servers 4-1 through 4-M may be used. For this reason, if there is a demand from the user to increase the storage capacity to be used, it is possible to allocate the storage sections of the plurality of storage servers 4-1 through 4-M for the storage of the data, for example, and it is possible to efficiently utilize the storage capacity and reduce the maintenance costs. In other words, when viewed from the virtual storage service provider, there is essentially no limit to the storage capacity usable for storing the data, and the storage servers 4-1 through 4-M are accessible in common from the ISP, ASP and the like. On the other hand, when viewed from the user, it is possible to reduce the communication charges at the time of storing the data and the communication charges at the time of referring to the stored data, by allocating for the storage of the data the storage section of a storage server which is near the content public server frequently accessed by the user or, the storage section of a storage server which is near the user.

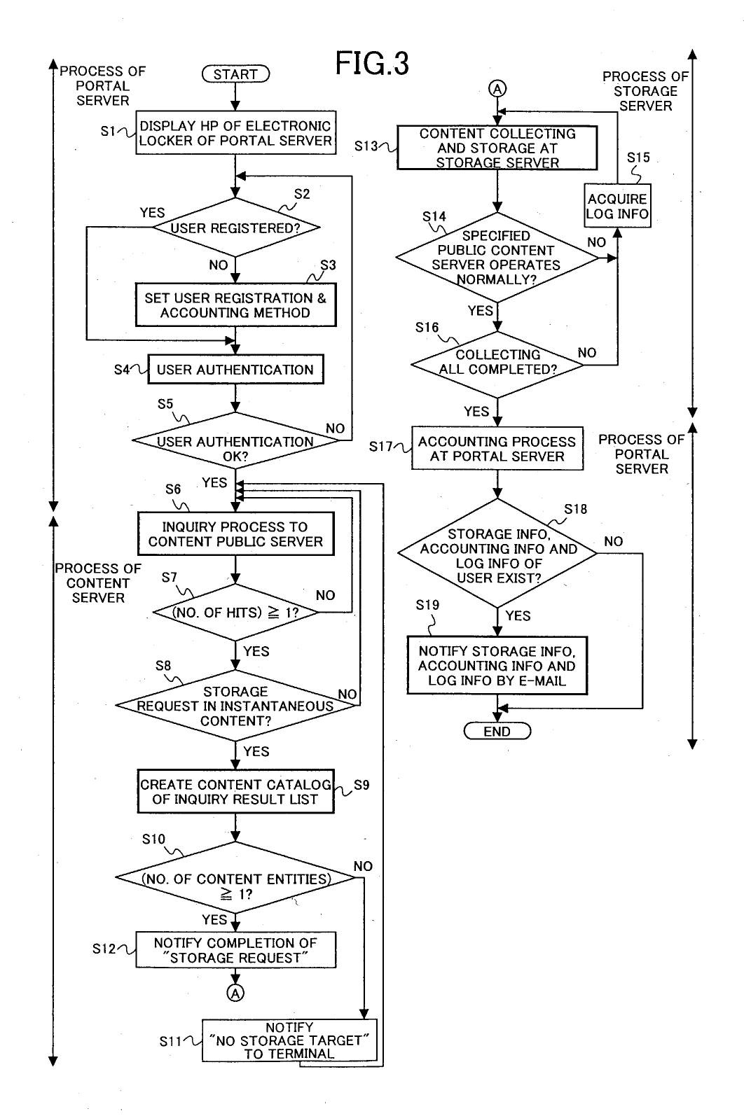

FIG. 3 is a flow chart for explaining a storage process,. In FIG. 3, steps S1 through S5 and S17 through S19 are carried out by the portal server 2, steps S6 through S12 are carried out by the content public server 3, and steps S13 through S16 are carried out by the storage server 4.

In FIG. 3, the step Si displays a homepage (HP) of the virtual storage service (rental virtual electronic locker service of the portal server 2 on the display part of the information terminal 5, and the step S2 decides whether or not the user making the access from the information terminal 5 is a registered user. If the decision result in the step S2 is NO, the step S3 carries out a user registration process and an accounting method setting process. The process advances to the step S4 if the decision result in the step S2 is YES or, after the step S3.

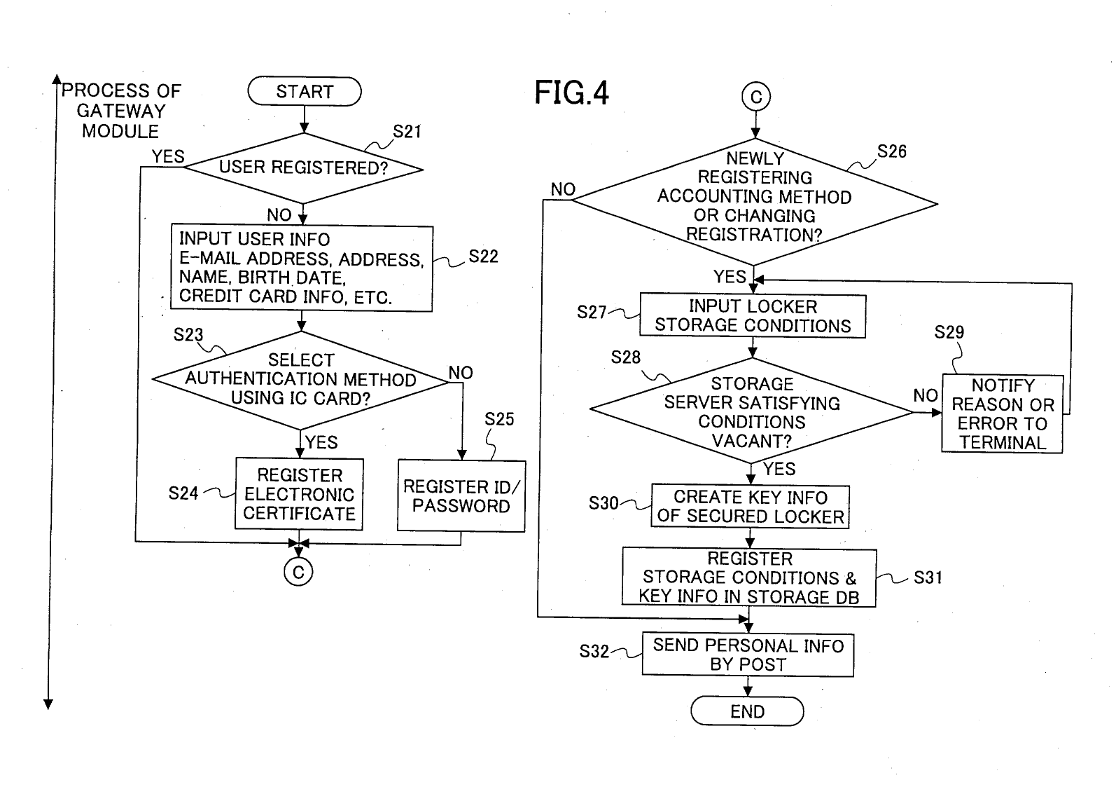

FIG. 4 is a flow chart for explaining the user registration process and the accounting method setting process of the step S3. Steps S21 through S32 shown in FIG. 4 are carried out by the gateway module 22 of the portal server 2.

In FIG. 4, the step S21 decides whether or not the user is registered. If the decision result in the step S21 is NO, the step S22 urges input of user information, and receives the user information input from the information terminal 5 by the user, such as an electronic mail (e-mail) address, address, name, birth date, and credit card information. The step S23 urges selection of an authentication method, and decides whether or not to use an IC card for the authentication. When using the IC card, the access from the information terminal 5 is made in a state where the IC card is connected to the information terminal 5 by a known method. If the decision result in the step S23 is YES, the step S24 registers an electronic certificate, and the process advances to the step S26. On the other hand, if the decision result in the step S23 is NO, the step S25 registers an ID or password, and the process advances to the step S26. The process advances to the step S26, also if the decision result in the step S21 is YES.

The step S26 decides whether or not the accounting method is to be newly registered or, decides whether or not the registered accounting method is to be changed. If the decision result in the step S26 is YES, the step S27 urges input of locker storage conditions, and receives the storage conditions input from the information terminal 5 by the user, such as a storage period, storage location, fixed-rate/variable-rate (or per-charge rate), usage or non-usage of enciphering, usage or non-usage of IC card, and alarm notification method.

For example, the storage period may be specified in units of days, and a plurality of locations may be specified as the storage location. The storage location is indicated by a locker number of the rental virtual electronic locker, for example. As will be described later, the plug-in module 32 of the server 3 generates routing information based on the storage location, and adds the routing information to the content which is to be stored. The plug-in module 32 stores the contents which is to be stored by carrying out a routing to the storage location, that is, the storage server 4 at a specified destination based on the routing information. According to the fixed-rate, a fixed charge is made in units of months or years, by setting an upper limit to the time and the amount of data stored at one time. According to the variable rate, a variable charge is made based on [(unit price)/(number of times)]×(number of times stored), for example, and an extra charge is made depending on the security level such as the usage or non-usage of the enciphering which is optional. The usage or non-usage of the IC card can specify whether or not the optional IC card is used. The alarm notification method can specify the notification method, such as how many days before the expiry of the storage period the notification is to be made and how frequently the notification should be repeated, and how an abnormal end of the storage process should be notified.

The step S28 decides whether or not a storage server 4 satisfying the locker storage conditions is vacant. If the decision result in the step S28 is NO, the step S29 notifies the reason of the error to the information terminal 5, and the process returns to the step S27.

On the other hand, if the decision result in the step S28 is YES, the step S30 creates key information of the locker which is secured, and the step S31 registers the locker storage conditions and the key information in the management database 44 of the storage server 4. After the step S31 or, if the decision result in the step S26 is NO, the step S32 sends personal information to the user of the information terminal 5 by postal service for the purpose of maintaining security, and the process ends. The personal information which is sent by the postal service includes the ID or password, the IC card including the electronic certificate, the accounting method and the like.

The key information may be selected from a common key which is obtained by enciphering the password and the content, a public key of the PKI, a privacy key and the like. In addition, when enciphering the content, it is possible to select the enciphering algorithm and the key length, so as to specify the security level of the content. Therefore, it is possible to take measures so that the user cannot read the stored content unless the user has the key. Of course, a known key may be used for the key itself.

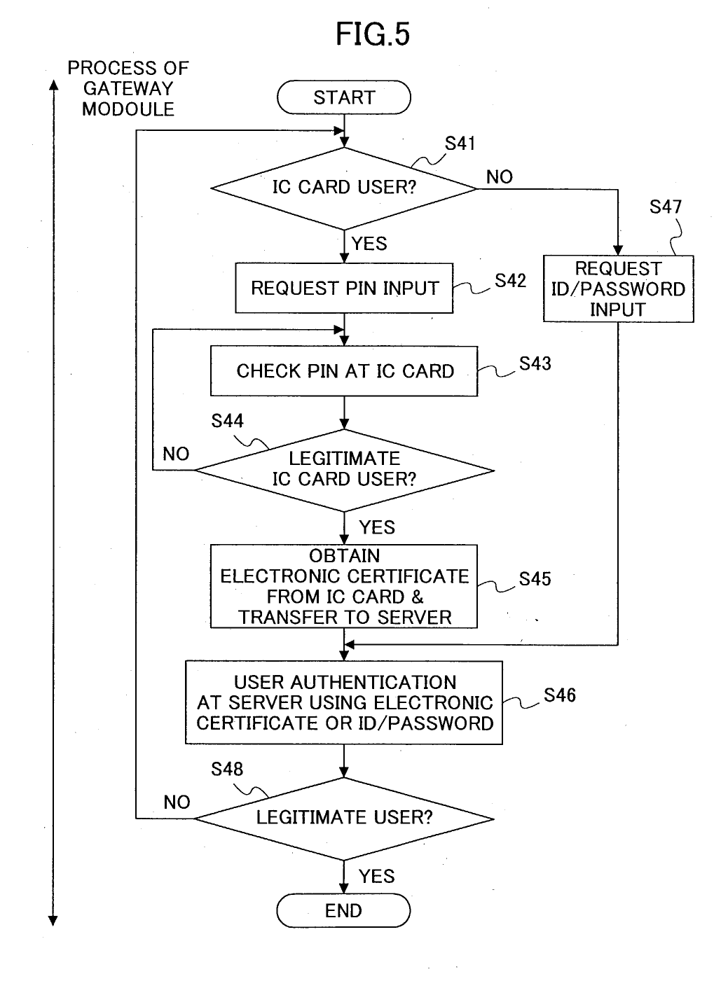

Returning now to the description of FIG. 3, the step S4 carries out a user authentication process. FIG. 5 is a flow chart for explaining the user authentication process of the step S4. Steps S41 through S48 shown in FIG. 5 are carried out by the gateway module 22 of the portal server 2.

In FIG. 5, the step S41 decides whether or not the user is an IC card user, based on the input from the information terminal 5. If the decision result in the step S41 is YES, the step S42 requests input of a personal identification number (PIN) of the IC card. The step S43 causes the IC card to check the PIN, and the step S44 decides whether or not the user is the correct IC card user. The process returns to the step S43 if the decision result in the step S44 is NO. On the other hand, if the decision result in the step S44 is YES, the step S45 obtains the electronic certificate from the IC card and transfers the electronic certificate to the portal server 2, and the process advances to the step S46. In addition, if the decision result in the step S41 is NO, the step S47 requests input of the ID or password of the user, and the process advances to the step S46.

After the step S45 or S47, the step S46 carries out a user authentication at the portal server 2, based on the electronic certificate or the ID and password. The step S48 decides whether or not the user is a legitimate user, and the process returns to the step S41 if the decision result in the step S48 is NO. On the other hand, if the decision result in the step S48 is YES, the process ends.

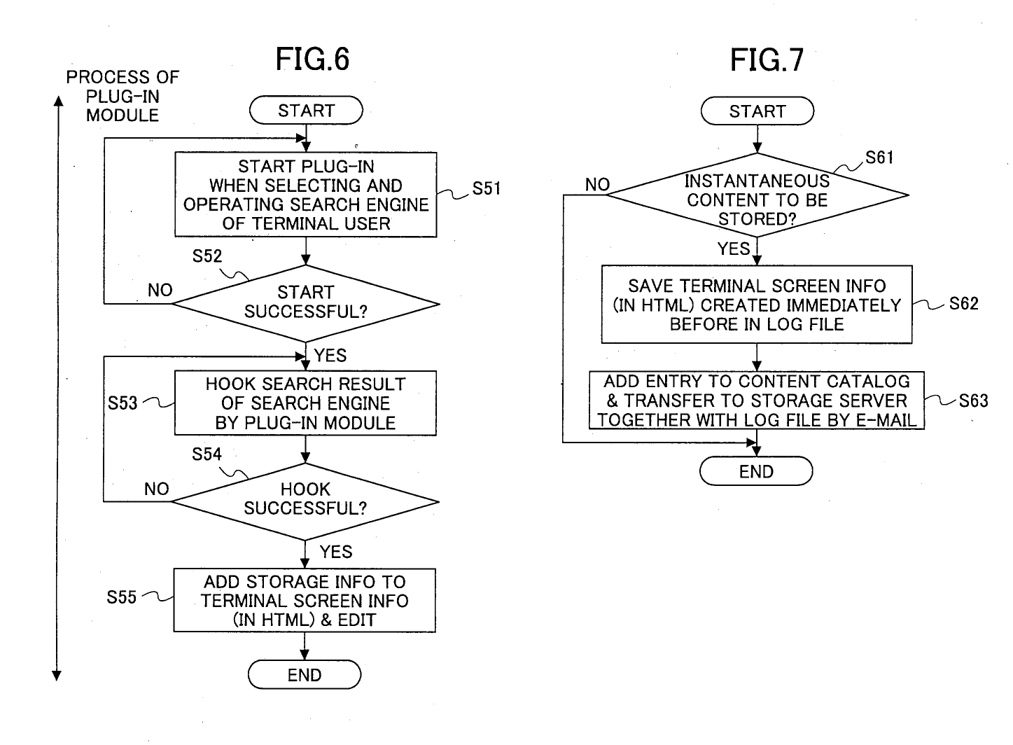

In FIG. 3, when the user authentication process of the step S4 ends, the step S5 decides whether or not the authentication result with respect to the user indicates that the user is the legitimate user. The process returns to the step S2 if the decision result in the step S5 is NO. On the other hand, the process advances to the step S6 if the decision result in the step S5 is YES. FIG. 6 is a flow chart for explaining an inquiry process to the content public server 3 carried out by the step S6. Steps S51 through S55 shown in FIG. 6 are carried out by the plug-in module 32 of the content public server 3.

In FIG. 6, the step S51 starts a plug-in when the search engine within the content access module 31 is selected and operated by the user of the information terminal 5. The step S52 decides whether or not the starting of the plug-in was successful, and the process returns to the step S51 if the decision result in the step S52 is NO. If the decision result in the step S52 is YES, the step S53 hooks the search result of the search engine by the plug-in module 32. The step S54 decides whether or not the hooking of the search result was successful, and the process returns to the step S53 if the decision result in the step S54 is NO. On the other hand, if the decision result in the step S54 is YES, the step S55 carries out an editing by adding storage information to screen information which is written in HTML (HTML screen information) and is for the information terminal 5, and the process ends.

In FIG. 3, when the inquiry process of the step S6 to the content public server 3 ends, the step S7 decides whether or not a number of hits is greater than or equal to one. The process returns to the step S6 if the decision result in the step S7 is NO. If the decision result in the step S7 is YES, the step S8 decides whether or not a storage request exists for an instantaneous content. The process returns to the step S6 if the decision result in the step S8 is NO. If the decision result in the step S8 is YES, the process advances to the step S9.

FIG. 7 is a flow chart for explaining a content catalog (instantaneous content) creating process for an inquiry result list, carried out by the step S9, to create the content catalog of the inquiry result list. Steps S61 through S66 shown in FIG. 7 are carried out by the plug-in module 32 of the content public server 3.

In FIG. 7, the step S61 decides whether or not an instantaneous content to be stored exists, and the process ends if the decision result is NO. On the other hand, if the decision result in the step S61 is YES, the step S62 saves the HTML screen information with respect to the information terminal 5, created immediately before, in the log file 23 of the portal server 2. In addition, the step S63 adds an entry to the content catalog, and transfers the content catalog which is added with the entry to the storage server 4 by e-mail, together with the HTML screen information saved in the log file 23, and the process ends.

In FIG. 3, when the content catalog creating process for the inquiry result list carried out by the step S9 ends, the step S10 decides whether or not the number of content entities is greater than or equal to one. If the decision result in the step S10 is NO, the step S11 notifies the information terminal 5 by sending thereto a message indicating that there is no storage target (data to be stored), and the process returns to the step S6. On the other hand, if the decision result in the step S10 is YES, the step S12 notifies the information terminal 5 by sending thereto a message indicating that the storage request is completed, and the process advances to the step S13.

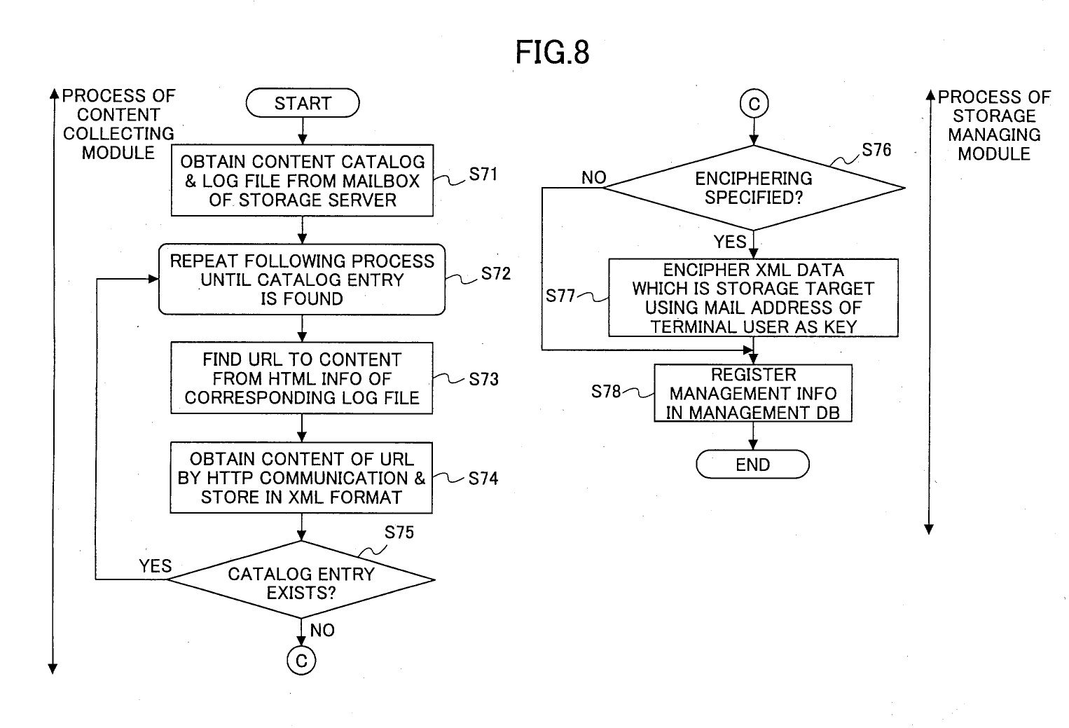

FIG. 8 is a flow chart for explaining a content collecting and storage process of the storage server 4 carried out by the step S13. In FIG. 8, steps S71 through S75 are carried out by the content collecting module 41 of the storage server 4, and steps S76 through S78 are carried out by the storage managing module 42 of the storage server 4.

In FIG. 8, the step S71 obtains the content catalog and the log file from the mailbox 45 of the storage server 4, and the step S72 repeats the steps S73 through S75 until a catalog entry is found. The step S73 finds the URL to the content from the HTML information of the corresponding log file 23. The step S74 obtains the content of this URL by HTTP communication, and stores the content with an XML format in the XML content file 43. The step S75 decides whether or not a catalog entry exists, and the process returns to the step S72 if the decision result in the step S75 is YES.

Hence, the instantaneous content is specified based on the original data generating the browser screen of the information terminal 5 and the operation specified (or instructed) by the user. If the URL exists within the specified instantaneous content, a page linked by this URL is dynamically accessed and added to the instantaneous content. By repeating such an operation, the content which is to be finally stored is generated as the XML content.

On the other hand, if the decision result in the step S75 is NO, the step S76 decides whether or not the enciphering is specified. If the decision result in the step S76 is YES, the step S77 enciphers the XML data which is the storage target, using the mail address of the user of the information terminal 5 as the key. If the decision result in the step S76 is NO or, after the step S77, the step S78 registers management information in the management database 44, and the process ends. The management information registered in the management database 44 includes an XML file name, storage period, enciphering method, number of times stored, amount of data stored, and the like. By registering the storage period, it is possible to notify the user (make an alarm notification) by e-mail or the like before the storage period expires, for example, and the stored data may be automatically deleted after the storage period expires and there is no request to extend the storage period.

Therefore, the data (content) which is stored in the storage server 4 by using the virtual storage service (rental virtual electronic locker service) includes various kinds of data such as a shopping list, a web site access log, a schedule, and an event.

In FIG. 3, when the content collecting and storage process of the step S13 ends at the storage server 4, the step S14 decides whether or not a specified content public server 3 is operating in a normal manner. If the decision result in the step S14 is NO, the step S15 acquires the log information from the log file 23, and the process returns to the step S13. On the other hand, if the decision result in the step S14 is YES, the step S16 decides whether or not the content collecting is all completed. The process returns to the step S15 described above if the decision result in the step S16 is NO.

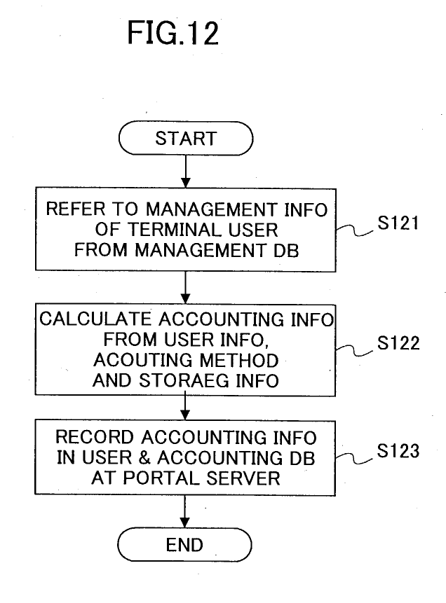

If the decision result in the step S16 is YES, the step S17 carries out an accounting process at the portal server 2. The accounting process will be described later in conjunction with FIG. 12. The step S18 decides whether or not the storage information, accounting information, log information and the like of the user exist. The process ends if the decision result in the step S18 is NO. On the other hand, if the decision result in the step S18 is YES, the step S19 notifies the storage information, the accounting information, the log information and the like to the information terminal 5 by e-mail, and the process ends.

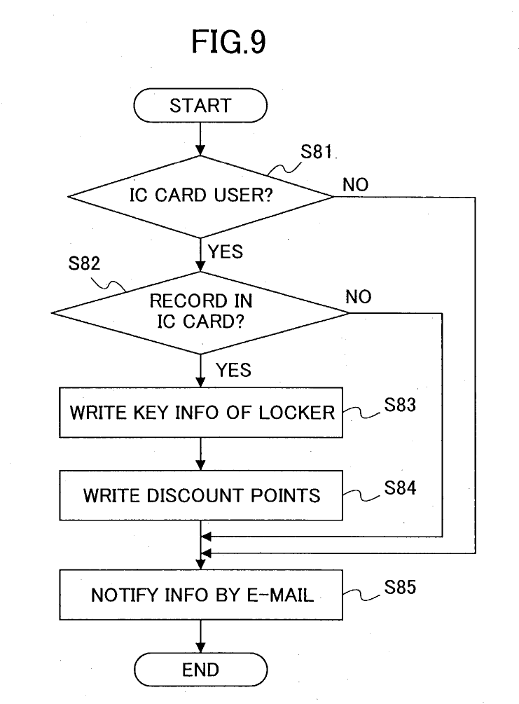

FIG. 9 is a flow chart for explaining a notification process for the storage information, the accounting information and the log information, carried out by the step S19. Steps S81 through S85 shown in FIG. 9 are carried out by the portal server 2.

In FIG. 9, the step S81 decides whether or not the user is an IC card user. If the decision result in the step S81 is YES, the step S82 decides whether or not the storage information, the accounting information and the log information are to be recorded on the IC card. If the decision result in the step S82 is YES, the step S83 writes the key information of the locker (locker key information) into the IC card, and the step S84 writes discount points into the IC card. In a case where the decision result in the step S81 or S82 is NO or, after the step S84, the step S85 notifies the log information, the locker key information and the like to the information terminal 5 by e-mail, and the process ends. The notified log information includes the discount points, the accounting information, the alarm information and the like.

Therefore, by writing the discount points and the like into the IC card, the user can receive a discount even for other offline services. In addition, as one mechanism for restoring the locker key, it is possible to store the key information in triplicate. In this case, the key information may be included in the management database 44, the IC card, and the e-mail to the user, for example.

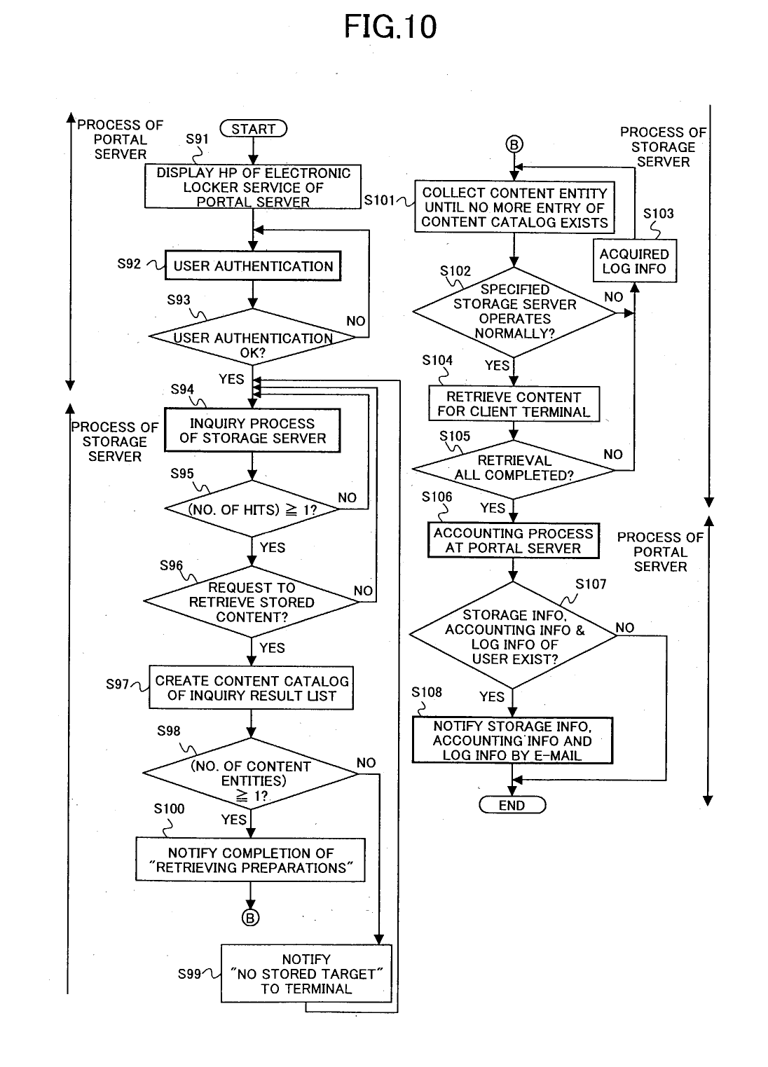

Next, a description will be given of a referring process which makes a reference to the stored data. FIG. 10 is a flow chart for explaining the referring process. In FIG. 10, steps S91 through S93 and steps S106 through S108 are carried out by the portal server 2, and steps S94 through S105 are carried out by the storage server 4.

In FIG. 10, the step S91 displays the homepage (HP) of the virtual storage service (rental virtual electronic locker service) of the portal server 2 on the display part of the information terminal 5, and the step S92 carries out a user authentication process similar to that carried out by the step S4 shown in FIG. 3. The step S93 carries out a process similar to that carried out by the step S5 shown in FIG. 3, and decides whether or not the authentication result indicates that the user is a legitimate user. The process returns to the step S92 if the decision result in the step S93 is NO. On the other hand, the process advances to the step S94 if the decision result in the step S93 is YES.

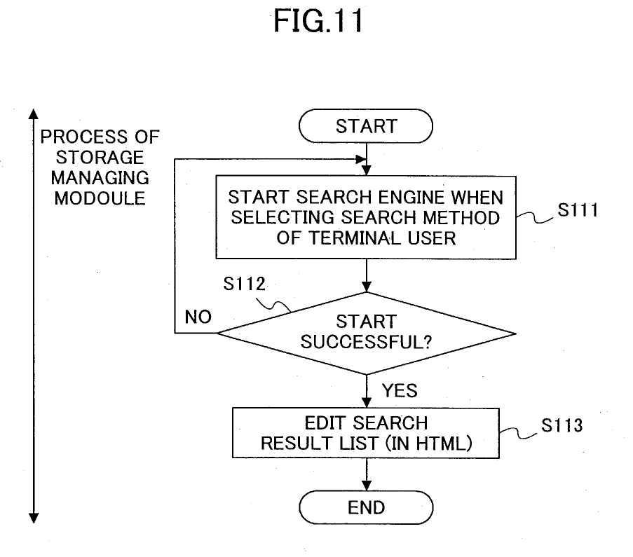

FIG. 11 is a flow chart for explaining an inquiry process to the storage server 4 carried out by the step S94. Steps Sill through S113 shown in FIG. 11 are carried out by the storage managing module 42 of the storage server 4. The step S111 starts the search engine when the user of the information terminal 5 selects the search method. The step S112 decides whether or not the starting of the search engine was successful, and the process returns to the step S111 if the decision result in the step S112 is NO. If the decision result in the step S112 is YES, the step S113 edits the search result list of the search engine in HTML, and the process ends. The search method may be selected from SQL search, keyword search, image search and the like.

In FIG. 10, when the inquiry process to the storage server 4 by the step S94 ends, the step S95 decides whether or not the number of hits is greater than or equal to one. The process returns to the step S94 if the decision result in the step S95 is NO. If the decision result in the step S95 is YES, the step S96 decides whether or not there is a request to retrieve the stored content. The process returns to the step S94 if the decision result in the step S96 is NO, and the process advances to the step S97 if the decision result in the step S96 is YES.

The step S97 carries out a content catalog creating process for the inquiry result list, to create the content catalog of the inquiry result list. This content catalog creating process can be carried out similarly to the content catalog creating process carried out by the step S9 shown in FIG. 3. After the step S97, the step S98 decides whether or not the number of content entities is greater than or equal to one. If the decision result in the step S98 is NO, the step S99 notifies the information terminal 5 by sending thereto a message indicating that there is no stored target (stored data), and the process returns to the step S94. On the other hand, if the decision result in the step S98 is YES, the step S100 notifies the information terminal 5 by sending thereto a message indicating that preparations for retrieving the stored content have been completed, and the process advances to the step S101.

The step S101 collects the content entities until there is no more entry in the content catalog, and the step S102 decides whether or not the specified storage server 4 is operating in a normal manner. If the decision result in the step S012 is NO, the step S103 obtains the log information from the log file 23, and the process returns to the step S101. If the decision result in the step S102 is YES, the step S104 retrieves the contents and sends the contents to the information terminal 5 of the user. Then, the step S105 decides whether or not the retrieval of the content is all completed. The process returns to the step S103 described above if the decision result in the step S105 is NO, and the process advances to the step S106 if the decision result in the step S105 is YES. Of course, the retrieved content may be written into the IC card or the like via the information terminal 5 if the user instructs such a writing of the retrieved content.

FIG. 12 is a flow chart for explaining an accounting process of the step S106. Steps S121 through S123 shown in FIG. 12 are carried out by the portal server 2.

In FIG. 12, the step S121 makes a reference to the stored information of the user of the information terminal from the management database 44 of the storage server 4. The step S122 calculates the accounting information from the user information, the accounting method and the storage information of the user. In addition, the step S123 records the calculated accounting information in the user and accounting database 24 of the portal server 2, and the process ends. The accounting process of the step S106 may be carried out similarly in the step S17 shown in FIG. 3.

The accounting information may be calculated in the following manner, based on variable parameters for measuring the frequency of use. In other words, when a member type of the user is represented by a weighting coefficient k, the weighting coefficient k is set to k=0.2 for an honorary member, k=1 for a regular member, k=1.1 for an associate member, and k=0.6 for a special member such as aged members. The storage period is represented by t for the present, and T for the accumulation. In addition, the storage size (capacity) is represented by s for the present, and S for the accumulation. Furthermore, the number of discount points are represented by p. The accounting information A in this case may be calculated from A=k×t×s×[(unit price)/minutes·KB]−(price per point)×p. In this case, p may be updated by setting p to be used the next time to p=p×1.01 if t+T>1000 hours, and to p=p×1.02 if s+S>1 GB.

After the step S106, the step S107 decides whether or not the storage information, the accounting information, the log information and the like of the user exist. The process ends if the decision result in the step S107 is NO. On the other hand, if the decision result in the step S107 is YES, the step S108 notifies the storage information, the accounting information, the log information and the like to the information terminal 5 by e-mail, and the process ends.

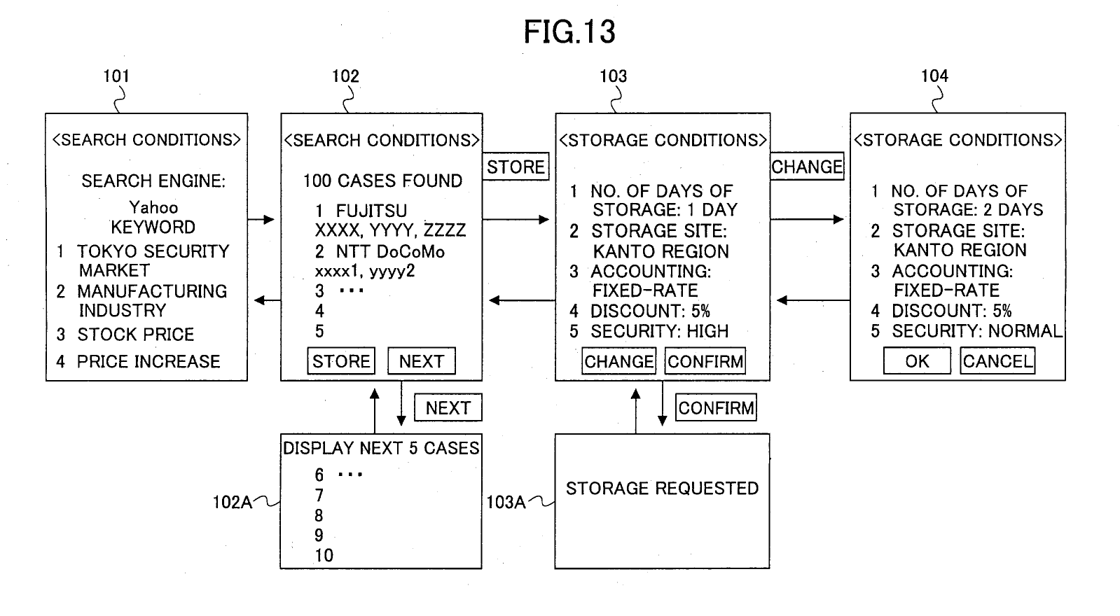

FIG. 13 is a diagram for explaining a display screen which is displayed on the display part of the information terminal 5 in this embodiment. In FIG. 13, when the user inputs the conditions shown on a search condition input screen 101, a search result output screen 102 for outputting the search result of the search engine is displayed. When a “next” button is selected on the search result output screen 102, the next five cases are displayed in the search result as indicated by a screen 102A. On the other hand, when a “store” button is selected on the search result output screen 102, a storage condition input screen 103 for inputting the storage conditions is displayed. If a “confirm” button is selected on the storage condition input screen 103, a message which confirms the storage, such as “storage requested” is displayed as indicated by a screen 103A. In addition, if a “change” button is selected on the storage condition input screen 103, changes such as that indicated by a screen 104 are input, for example. In this case, the number of days of storage and the security level are changed. When an “OK” button is selected on the screen 104, the message of the screen 103A is displayed. Moreover, when a “cancel” button is selected on the screen 104, the operation of changing the storage conditions is cancelled. When making a reference to the stored search result, the stored site (stored location) is specified after the user authentication process, and the stored search result is retrieved from the storage server and displayed on the screen 102 or 102A.

Further, the present invention is not limited to these embodiments, but various variations and modifications may be made without departing from the scope of the present invention.

1. A virtual storage system which stores data generated by a search engine on the Internet according to a request from an information terminal, comprising:
a storage server which stores the data generated by the search engine, by receiving the data without passing the data through the information terminal.

2. The virtual storage system as claimed in claim 1, further comprising:
a content public server which includes the search engine, and a plug-in module which transfers the data generated by the search engine to the storage server without passing the data through the information terminal.

3. The virtual storage system as claimed in claim 2, further comprising:
a portal server which starts the plug-in module of the content public server according to a request from the information terminal.

4. The virtual storage system as claimed in claim 3, wherein the portal server includes a module for carrying out an accounting process related to storage of the data.

5. The virtual storage system as claimed in any of claims 2 to 4, wherein the plug-in module of the content public server manages notifications related to storage of the data, including an alarm notification with respect to the information terminal.

6. The virtual storage system as claimed in any of claims 1 to 5, wherein the storage server transfers stored data to an arbitrary information terminal according to a request from the arbitrary information terminal.

7. A virtual storage service providing method which provides a service for storing data generated by a search engine on the Internet according to a request from the information terminal, comprising:
a step of storing the data generated by the search engine without passing the data through the information terminal.

8. The virtual storage service providing method as claimed in claim 7, further comprising:
a step of causing a portal server to start a plug-in module of a content public server according to a request from the information terminal, with respect to the content public server which includes the search engine and the plug-in module which transfers the data generated by the search engine to the storage server without passing the data through the information terminal.

9. The virtual storage service providing method as claimed in claim 8, further comprising:
a step of causing a module of the portal server to carry out an accounting process related to storage of the data.

10. The virtual storage service providing method as claimed in claim 8 or 9, further comprising:
a step of causing the plug-in module of the content public server to manage notifications related to storage of the data, including an alarm notification with respect to the information terminal.

11. The virtual storage service providing method as claimed in any of claims 7 to 10, further comprising:
a step of causing the storage server to transfer stored data to an arbitrary information terminal according to a request from the arbitrary information terminal.
